(19) United States
(12) Patent Application Publication
(10) Pub. No.: US 2015/0003296 A1
(43) Pub. Date: Jan. 1, 2015

(54) SYSTEM AND METHOD FOR PROVIDING P2P BASED RECONFIGURABLE COMPUTING AND STRUCTURED DATA DISTRIBUTION

(71) Applicants: Hongbing Fan, Waterloo (CA); Yue-Ang Chen, Kitchener (CA)

(72) Inventors: Hongbing Fan, Waterloo (CA); Yue-Ang Chen, Kitchener (CA)

(21) Appl. No.: 14/370,768

(22) PCT Filed: Oct. 3, 2012
(86) PCT No.: PCT/CA2012/000912

§ 371 Date: Jul. 4, 2014

Related U.S. Application Data
(60) Provisional application No. 61/582,894, filed on Jan. 4, 2012.

(51) Int. Cl. H04L 12/24; H04L 29/08

(52) U.S. Cl. CPC H04L 41/0803; H04L 67/104
USPC 370/255

(57) ABSTRACT

The present invention and its embodiment propose a P2P based reconfigurable computing system and method for the design and reconfiguration of structured overlay networks, and data distribution and running application along overlay networks. The system includes a group of peer nodes, a console and a graphical user interface control panel for interconnection reconfiguration and application management. The system provides a platform to design, and to deploy and to run distributed computing applications over a plurality of peer nodes. The data distribution method together with optimal network topology makes it efficient to distribute data among distributed computing components. The computer aided design tool helps in finding the optimal topology for given types of applications, it provides configuration computing and generation and deployment which make the design and operation of applications automatic.

### PRIORITY CLAIM

This patent application claims priority to U.S. Provisional Patent Application 61/582,894.

### FIELD OF INVENTION

The present invention relates to reconfigurable computing and distributed/parallel computing over a large number of computers and computing devices by the method of peer-to-peer (P2P) interconnection. More particularly the invention relates to the design and reconfiguration of structured P2P overlay networks for data distribution used by applications.

### BACKGROUND

Peer-to-peer (or “P2P”) based content distribution technology has been widely used in content distribution on the Internet. Popular applications include for example Bit Torrent for file sharing, Skype for VoIP, and PPTV for IP video. Most existing P2P applications use a non-structured overlay network method, in which a connection from one peer to another is established when data transfer between them is required, and then disconnected when the data transfer is done. Applications using the non-structured interconnection method are flexible and scalable with respect to coming and leaving of peers. The disadvantage of the non-structured interconnection method is the overhead that is required in the overlay network configuration during data distribution, and the lack of overall control and management of peers in computing scheme.

On the contrary, the structured overlay network method first sets up an overlay network connecting a group of peers in a defined topology, then distributes data along the overlay network. The advantages of the structured overlay network method are the simplicity in data distribution protocol and low overhead in interconnection reconfiguration and efficiency in data distribution with the use of optimal overlay network topology and parallel processing mechanisms. The structured overlay method is suitable for example for data distribution and exchange in distributed computing applications running on multiple networked machines.

One disadvantage of prior art P2P technologies utilizing structure overlay networks is that they generally require a centralized architecture, which generally increases the resources required to manage the P2P networks that are associated with a central manager, and also increases the network resources required to implement P2P operations.

Examples of prior art that relate to the P2P domain include:

U.S. Pat. No. 7,600,012 relates to a method for managing computing elements on peers.

United States Patent Application No. 2005/0163061 discloses a technology for discovering peers in a P2P network.

United States Patent Application No. 2009/0282105 discloses a P2P data delivery system, a P2P data delivery method, and a P2P data delivery program. It provides methods for shared public data delivery and data query.

United States Patent Application No. 2008/0130516 P2P discloses an overplay network construction method and apparatus. It provides a method to build distributed hash table (DHT) based overlay network.

United States Patent Application No. 2008/014462 discloses a system and method for peer to peer, video streaming. It provides Internet Protocol Television (IPTV) system for video streaming through a P2P network.

U.S. Pat. No. 7,764,622 discloses an interplanetary communications network, an interplanetary communications network backbone and a method of managing interplanetary communications network.

U.S. Pat. No. 7,890,449 discloses an interplanetary communications network and a method of managing interplanetary communications. It uses delay matrix to find optimum end-to-end data path. A method is provided for performance bottleneck diagnosis and dependency discovery in distributed systems and computer networks. It provides methods for end-to-end measurements and real-valued delay matrix, and bottlenecks dependencies of distributed systems.

There is a need for a P2P computing platform, and associated P2P computer implemented methods that address the problems mentioned above.

### SUMMARY

In one aspect, a computer implemented method is provided for configuring and reconfiguring peer-to-peer (“P2P”) networks is provided characterized in that the method comprises: (A) designing and configuring a structured overlay network for defining a P2P network; (B) generating network instructions using one or more protocols that define a packet format, the network instructions being operable to define the structured overlay network; and (C) distributing the network instructions to two or more network-connected host devices so as to define dynamically the structured overlay network, such that each host device is a peer node, and the structured overlay network enables data exchanges between peer nodes to as to enable peer-to-peer operations between the peer nodes.

In another aspect, the structured overlay network defines a decentralized network architecture that enables file distribution, data synchronization or search, over the host devices.

In another aspect, the structured overlay network creates dynamic structured data paths between peer nodes.

In another aspect, the structured overlay network enables the implementation of distributing computing applications across the P2P network. In another aspect, the P2P networks are flexible and scalable, and also enable control of peers that permits configuration and reconfiguration.

In another aspect, the network instructions may be adapted to define P2P network closure parameters that are triggered to close the P2P network.

In yet another aspect, the network instructions are in the form of network packets, and these define for each peer node, an incoming channel and an outgoing channel, and further define a channel handler for each incoming channel for controlling the network packets.

A computer network implemented system is provided for configuring and reconfiguring peer-to-peer (“P2P”) networks characterized in that the system comprises: (A) a P2P network manager implemented to a server computer, the P2P network manager being configured to: (i) generate network instructions using one or more protocols that define a packet format, the network instructions being operable to define ae structured overlay network: and (ii) distribute the network instructions to two or more network-connected host devices so as to define dynamically the structured overlay network, wherein each host device is a peer node, and the structured overlay network enables data exchanges between peer nodes to as to enable peer-to-peer operations between the peer nodes.

In another aspect, the computer system comprises two or more network-connected devices that after receiving the network construction include a peer node component, and function as peer nodes in a decentralized P2P network.

In a still other aspect, the structured overlay network defines a decentralized network architecture that enables file distribution, data synchronization or search, over the host device.

In a still other aspect of the computer system, the network instructions are in the form of network packets, and these define for each peer node, an incoming channel and an outgoing channel, and further define a channel handler for each incoming channel for controlling the network packets.

In a still other aspect, the P2P network manager is operable to: (A) retrieve an overlay network topology and an overlay network topology expression; and (B) apply an overlay network topology for data distribution and reconfiguration context generation.

In a still other aspect, the network instructions define on each peer node a worker component that monitors and controls peer node functions.

In a still other aspect, of the computer system the network instructions are in the form of network packets, and these define for each peer node, an incoming channel and an outgoing channel, and further define a channel handler for each incoming channel for controlling the network packets.

### BRIEF DESCRIPTI/ON OF THE DRAWINGS

FIG. 1 is a block diagram illustrating the architecture of the P2P based reconfigurable computing system associated with the present invention;

FIG. 2 is a block diagram illustrating the architecture of peer nodes;

FIG. 3a consists of a block diagram illustrating a possible packet format for the present invention.

FIG. 3b is a block diagram illustrating a possible protocol stack for enabling the P2P based reconfigurable computing system;

FIG. 4 is a block diagram illustrating the console with connection to a login peer node;

FIG. 5 is a black diagram illustrating the connection channel. It can be configured to TCP, UDP, or SSL for secured connection;

FIG. 6 is a diagram illustrating nets of an overlay network in the display window of GUICP;

FIG. 7 is a block diagram illustrating the packet switching inside a peer node. Switch scheme follows the specified protocols;

FIG. 8 is a block diagram illustrating the topology of path, star, tree, ring, and a general directed graph;

FIG. 9 is the chart of CAD design flow for overlay network topology; and

FIG. 10 is a table for Load Balancing Data Distribution.

### DETAILED DESCRIPTI/ON

The present invention provides a computer system for establishing reconfigurable structured overlay networks of peer computers/devices, and a method for the design and reconfiguration of structured overlay networks as well as the execution of data distribution and applications along the structured overlay networks of the present invention. The computer system is based on a decentralized architecture and can be directly used for applications such as file distribution, file/data synchronization, and file search over a plurality of computers. Moreover, it can be used as a computer platform to develop and run distributed computing applications over a plurality of networked computers.

A novel and innovative system (implemented as a computer system as described below) and set of mechanisms (implemented as a set of computer implemented methods) is provided for constructing P2P networks. A P2P based reconfigurable computing platform is disclosed that enables the development and implementation of distributed computing and distributed data distribution methods over clusters, grids, and cloud infrastructure.

The P2P networks enabled by the present invention are flexible and scalable and yet provide sufficient control of peers to permit configuration and re-configuration for a wide variety distributed computing applications. The control of peer nodes provided by the present invention also ensures that P2P networks configured and managed by operation of the present invention have desirable reliability, security, throughput and latency characteristics.

The present invention accomplishes this without the need for the significant overhead that accompanies prior art P2P networks (described above) by providing the degree of control of peers for multiple applications provided by the present invention. Prior art P2P networks that provide adequate reliability, security, throughput and/or latency characteristics are generally implemented using dedicated P2P protocols for specific applications, which generally limits the number of applications and increases the resources required for deploying and supporting multiple applications.

Furthermore, these prior art P2P platforms generally do not use dynamically built data path connecting peer nodes for data exchange, as a result the data exchange performance cannot be predicted accurately. In contrast, the present invention enables P2P applications to operate more efficiently by being flexible enough to permit data exchange among distributed computing components with given time closure by means of a dynamic structured data path.

Also, a traditional P2P application usually requires a program component on each peer node, and this programming, based on prior art methods, generally needs to be updated in order to support for example different P2P network configurations, or for example to permit the implementation of a new features or a new distributed data distribution process. The requirement to distribute updated programming across the peers may require significant overhead. In particular, significant network management resources may be required, which usually involves configuration of a centralized network manager that generally involves investment of significant resources. In addition, prior art P2P methods may also require relatively significant resources from host computers acting as peer nodes. Furthermore, the communication of updated programming, and instructions for configuring updated programming, across the various peers using a communication network, can use significant and costly network resources.

These factors, practically speaking, place limits on the use of P2P networks, and in effect explain why the use of P2P networks currently is not widespread in enterprise computing.

The present invention represents significant innovation over the prior art and in effect expands the range of application of P2P network implementations. The present invention enables easy reconfiguration of P2P applications and processes, and development/implementation of new P2P applications, in a way that was not possible prior to the invention. Also, the present invention makes it more viable to reconfigure existing P2P networks based on changing parameters. For example, the present invention enables the configuration of P2P networks so as to provide adaptive P2P networks that enable application of P2P methods in domains where P2P networks were not previously possible, such as in smart grid applications as explained below.

Specifically, in accordance with the present invention, data distribution methods may be constructed using a P2P network that includes standard host devices as peer nodes, where the P2P network may be re-configured dynamically, so as to enable the adaptation of data distribution methods for example based on changing network parameters re-configuring the P2P network dynamically, as often as required for example to implement the structured data distribution methods by configuring each peer node to establish the data path so that data including configuration data is distributed along the data path efficiently, and disconnected after the data distribution is done.

In one aspect of the invention, a P2P based reconfigurable computing system of the present invention is provided that comprises (1) a group of peer nodes, (2) a console for network commands, (3) a graphical user interface control panel (GUICP) for the monitoring and operations of P2P overlay networks, and (4) a computer aided design (CAD) utility (which may be implemented as a toolkit for network topology computing and reconfiguration context generation and application development. A peer node is a client and server program embedded and running on a networked host computer or device. It can accept connection requests from console, GUICP, or other peer nodes to establish incoming communication channels (or simply channel), and to execute a specific set of network instructions coming from channels carried by packets. It can make connection requests to other peer nodes to create outgoing channels and send network instructions through channels. Data packets can be transferred in both directions of a channel. A channel can be assigned a net identifier (NID) and connected channels of the same NID form a net, which is the fundamental data path for one-to-many intercommunication of computing components in distributed computing applications. A net is used to distribute data packets carrying network instructions or application data. Two nets with different Nibs do not interfere even if they may share some common peer nodes. The overlay network of an application consists of a group of nets, which can be established or reconfigured statically before running the application or dynamically within the execution of the application. Significantly, using the overlay networks of present invention, two different applications do not interfere if they do not share a common channel of the same NID. The console is used to log onto a peer node to issue network commands, such as creating overlay networks, retrieving interconnection topology, sending/receiving application data, and launching and managing application programs. Commands are carried out by packets carrying the network instructions. Peer nodes take actions according to the instruction in the packet. The GUICP is used to Monitor the interconnection of peer nodes and to do overlay network reconfiguration in the form of graphical display and pointing devices.

The method comprises (1) distributing to two or more network-connected host devices with one or more protocols that define a packet format configured to carry network instructions for distribution along an overlay network linked to the host devices, (2) the protocols establishing a structured overlay network of peer nodes, wherein each host device is a peer node, (3) the protocols forwarding data packets from one incoming channel to one or more outgoing channels at a peer node, (4) optionally using one or more mechanisms (which may be implemented using one or more algorithms implemented using a network manager modified in accordance with the present invention, to retrieve an overlay network topology and an overlay network topology expression, (5) using a packet handling scheme on both sides of a channel, (6) designing and configuring the structured overlay network based on a workflow initiated by a CAD design tool, (7) applying and overlay network topology for data distribution and reconfiguration context generation.

Within an application, the system of the present invention plays a role of communication middle ware to handle the intercommunication of computing components of applications running on different host computers. Structured overlay network is established through reconfiguration of the peer nodes, followed by data exchange among the computing components. The present invention uses file distribution as an example to illustrate the application of the P2P based reconfigurable computing system as well as the methods for data distribution along structured overlay networks.

Another example is data synchronization, in which bidirectional data paths are established to connect multiple nodes, data packets from any node is distributed to other nodes on the data paths. In contrast, prior art synchronous approaches generally use a centralized architecture, resulting in the aforementioned overhead requirements.

The present invention uses one configuration packet generated from a console, which automatically splits at the fork nodes of structured data path so as to reduce overhead associated for example with reconfiguration. In contrast, prior art approaches usually send multiple packets, one for each of the nodes, resulting in much higher overhead.

The inventors have discovered that P2P networks may be configured and managed using computer system components and networking methods based on packet based communications, applied in a novel and innovative manner. Some prior art platforms use high level message-based protocols to enable intercommunication between peer nodes. In contrast, the present invention uses packet based stream communications on structured overlay networks to enable one-to-many communications that are directed by a P2P network manager to provide reconfigurable P2P networks.

The P2P computing platform in accordance with the present invention is more flexible and scalable than prior art platforms, thereby enabling the flexible and efficient deployment of large scale applications. The computer platform's flexibility permits adding and removing applications, and supports multiple applications running simultaneously.

The present invention simplifies the required intercommunications from the perspective of the peer nodes and shifts resources to the P2P network manager, and also to the application development process. Moreover, the present invention discloses specific utilities that simplify the development of P2P applications.

A skilled reader will understand that the present invention provides a series of innovative tools and processes for enabling a P2P network infrastructure based on packet based communications.

In one aspect of the present invention, a computing platform is provided that is based on a unique and innovative distributed architecture that enables a plurality of network-connected host devices, and at least one P2P network manager, to function as a reconfigurable P2P network. The P2P network manager may be implemented as an operation software component that also includes or links to one or more application programming interfaces (APIs). These components may be installed for example on one or more server computers associated with one or more data processing hubs or operation centers that are configured to manage a P2P network in accordance with the present invention. The P2P network also includes a peer node component that is installed at each network-connected device that is to function as a peer node. The peer node component interoperates with the P2P network manager, and enables the participating network-connected devices to function as peer nodes in a decentralized P2P network in accordance with the present invention.

In one aspect, the peer node component enables network-connected devices to function as communication gateway devices that exchange packet based communications with the P2P network manager in order to provide a managed P2P network.

The peer node component may consist of a peer node computer program loaded on each participating network-connected device. The peer node component may also be implemented as hardware, for example by implementing the communication gateway features to a computer processor or component of a computer processor that is made part of the participating network-connected devices.

In addition, the computer system may include a P2P application development platform that permits the development and deployment of P2P applications to communication networks. The P2P application development platform may include a series of tools or utilities similar to those of other application development platforms, but that also automatically integrate P2P network features as described in this disclosure. For example, the P2P application development platform may include or be associated with a software development kit (SDK) for enabling developers to design and develop P2P applications that may be implemented using the P2P computing platform of the present invention. For example the SDK may contain programming tools for computing component development, P2P platform application interfaces, commonly used reconfigurable components, as well as a high level application description language and associated computer aided design (CAD) tools. The SDK may include an advanced visual programming interface for designing and implementing P2P applications.

Developers using the SDK may specify the functionalities of peer node components and input/outputs of the computing components required by an application, and one or more CAD tools may generate the computing components for different nodes, and enable these to be mapped to available peer nodes, and computing the data path topologies and configuration context. Most parts of an P2P application will be generated in an automatic manner such reducing the difficulties in developing complex P2P applications.

The P2P network manager may include one or more tools for managing aspects of the P2P network. In one aspect of the P2P network manager, the P2P network manager provides one or more dashboards that provide a control interface for managing the structured overlay networks of the present invention. One implementation of the control interface is referred to as a “GUICP” in this disclosure. A peer node can be configured to report itself to the GUICP. In one implementation, the GUICP displays the available peer nodes and their interconnection relations with each other with various layouts. Users can use the device to connect or disconnect two peer nodes, which internally sends configuration packet to the relevant nodes. Peer nodes can be organized into groups. The GUICP may include an interface for peer nodes group management, so that user can select a particular group to focus on and launch application on the group. The GUICP may contain application launchers. The GUICP may also contain a launch button for a command console that may use available network commands for the P2P network.

The peer node may be implemented as a program that serves as both client and server and runs on a host computer or a computing device. The use of peer nodes in the manner disclosed herein provides unique and innovative adapted packet based communications, managed by the P2P network manager, enabling easy to configure and re-configure P2P networks, adaptable for many different applications, without the need for significant overhead, and such that control of the peer nodes is provided for supporting P2P applications with desirable reliability, security, throughput and latency characteristics.

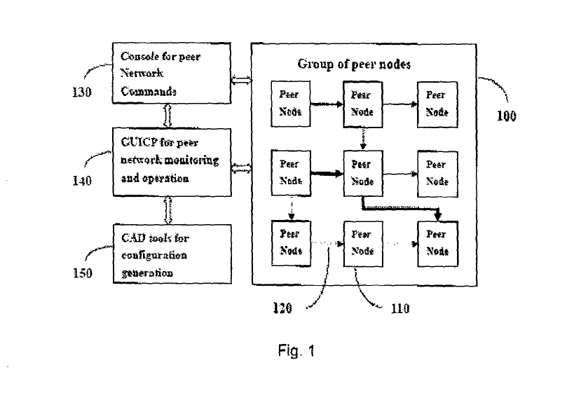

Referring to FIG. 1, the P2P based reconfigurable computing system in one implementation comprises a group of peer nodes (100), a console (130) system for processing network commands at each peer node (110), a P2P network manager, which may be implemented as a GUICP (140) for monitoring and operations of overlay networks, and a P2P network design utility or CAD tool (150) (which may be implemented as a CAD based network design toolkit) for enabling overlay network topology computing, reconfiguration context generation, and application development.

A skilled reader will appreciate that CAD tool (150) may be implemented as an overlay network design tool may include features similar to those used in CAD tools used in EDA (electronic design automation), for designing computer processors for example. The CAD tool enables users to develop large and complex distributed application, including numerous components, running on an important number of computers, with complex communication paths between them. The CAD tool may be used by users to select the various components of a network topology that enables a P2P network, or network application, as described, define the relationships between them, and the associated network overlay may be generated automatically by operation of the CAD tool of the present invention.

A skilled reader will understand that for example when a P2P network topology is required that involves connecting a source and 100 hundred destination nodes located in different places, it is very difficult for user to determine an effective topology. The CAD tool may implement for example different types of Steiner tree algorithms, which is operable to take the input source, the destination, and the delay matrix, and returns the best tree which can be directly used to make the connections.

A person skilled in the art will understand that the P2P network manager may implement technologies for creating and managing overlay networks that are well known in the domain of networking. The present invention contemplates the use of various existing and to be invented technologies for enabling a structured overlay network. One contribution of the present invention is how to configure a structured overlay network in order to enable a wide range of P2P applications, in a way that is flexible, scalable, and does not require addition of significant resources by network providers or changes to network provider procedures or protocols.

It should be understood that the peer nodes (100) may be implemented in a number of ways. For example, the may be embedded in a mobile device, and the connections to other peers may be provides using wireless communication channels such as Bluetooth, WiFi or GSM. This enables for example nearby devices to communicate with one another in order to share data. It should also be understood that the present invention, with its flexibility, permits the configuration of various applications that involve different implementations that incorporate P2P networks, including applications that utilize mobile devices as peer nodes based on a number of different topologies. Furthermore, the inventions makes this possible, while enabling configuration and reconfiguration of these applications with little overhead.

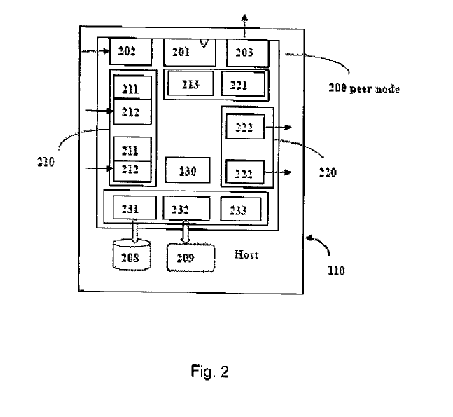

FIG. 2 illustrates a representative architecture of a peer node, in accordance with the present invention. Referring to FIG. 2, a peer node may consist of a P2P computer program of the present invention, embedded on a network-connected host computer. In one aspect of the invention, a peer node computer program in accordance with the present invention may include (A) a client program component and (B) a server program component embedded and running on a networked host computer or device. The client program and the server program are operable to configure the host computer both (A) as a client computer, and (B) as a server computer, in the overall P2P network established in accordance with the present invention. As a client, the host computer can make a connection request to another peer to create a TCP/UDP/SSL outgoing channel (222). As a server, the host computer waits for the incoming request for TCP/UDP/SSL connection through the server socket (201). For a connection request, the host computer establishes an incoming channel (212) and a channel handler (211) to listen, to pick up and to process packets arriving via the incoming channel. The P2P computer program configures the host computer to interoperate with another host computer that is part of the P2P network so that outgoing and incoming channels pair automatically to form a communication channel (222, 212) between two peer nodes. A connection channel can be unidirectional or bidirectional. An incoming channel routing table (213) and outgoing channel routing table (221) store the information of communication channels of the peer node. In one implementation, the channel handler (211) is configured to implement various processes required after the peer node receives a packet. For example, a channel handler (211) is may implement PSRIN protocols for this purpose, as explained below.

In accordance with the present invention, a packet may carry routing information, network instructions, routing data, and application data, for supporting P2P computing operations. Each incoming channel has a channel handler (211), which may take action according to the information carried in a packet. For example, the channel handler (211) can forward the packet from the incoming channel to one or more outgoing channels of the peer node according to the instruction and routing information carried in the packet and outgoing channel routing tables. The channel handler (211) creates a processing object (230), which then produces packets and then forwards the packets to outgoing channels respectively, collects feedback packets from multiple outgoing channels, and creates reply packets and sends them to the incoming channel.

A peer node may also create application objects (231, 232, 233), for example to create a file 110 (208), to communicate with external processes (209), and to perform peer-to-peer computing with peer node (233). The peer node can communicate with other processes and by running locally on the peer node. The forward/reply packets can be incorporated with the application data from local host.

A peer node may be identified by a peer node address that may consist of its IP address and a port number or a specific identity. Interconnection relation and functional modules can be added to a peer node through reconfiguration of the peer node. Configuration can be done statically in connection with the configuration of the peer node for example using the configuration file, or dynamically through configuration instructions carried by packets.

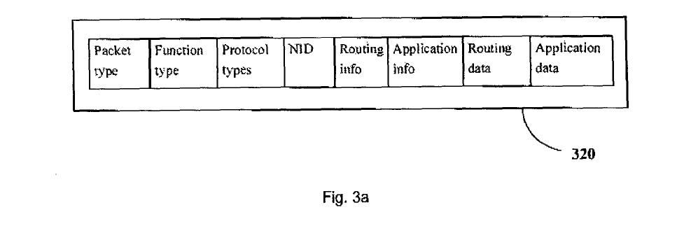

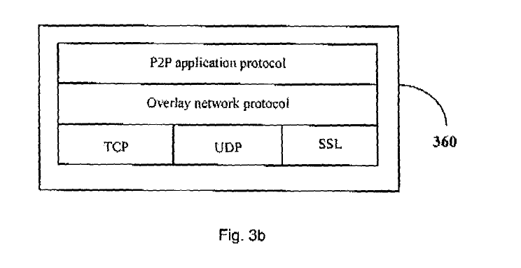

FIG. 3a illustrates a possible packet format for a packet based communication protocol for enabling the network communications that enable the P2P network of the present invention. A skilled reader will understand that other packet formats are possible. FIG. 3b illustrates a protocol stack used by the P2P based reconfigurable computing system of the present invention. A skilled reader will immediately appreciate that the protocol stack shown is an example only and various other protocol stacks are possible.

Referring to FIGS. 3a and 3b, the communication between peer nodes, the console and the GUICP may be enabled through packet-switched interconnections. In one implementation of the invention, as shown FIG. 3a, the packet format (320) used by the P2P network may include the following fields: packet type, function type, distribution protocol types, NID, routing information, application information, routing data (optional and with variable length) and application data (optional and with variable length). The packet handling protocols generally sit between the TCP/UDP/SSH protocols. Application protocols are shown in the protocol stack (360) of FIG. 3b.

A packet can carry instructions to the peer node to take particular actions related to P2P network operations. Each instruction may be associated with a specific value or function type. Basic instructions may include for example:
(1) connect/disconnect a communication channel from one peer node to another peer node,
(2) tag/untag NID to an outgoing channel,
(3) trace the interconnection topology of a net with an NID,
(4) send/receive data along a net with specific NID,
(5) install/uninstall, register/deregister an application along a net,
(6) make a system/command call on a peer node of a net with specific NID,
(7) input/output the application data of a process/thread of a running program,
(8) open/close buffer or file handler,
(9) put data to a specified buffer or file handler or to specified outgoing channels, or
(10) forward a packet to specified outgoing channels.

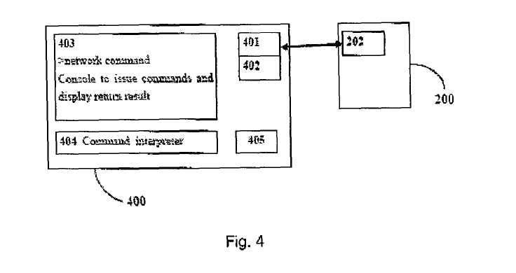

Referring to FIG. 4, the console may be implemented as a command line user interface that is configured to enable peer node network operations. Through a console (130), it is possible to log into a peer node to issue peer node network commands, and to collect outputs of computing that has been completed by the peer (for example in connection with distributed processing implemented using the P2P network of the present invention).

As shown in FIG. 4, the console system may include:
(1) a module (401) for making a request for a TCP connection to the server module (201) of peer nodes,
(2) a socket listener and handler (402) for processing the returning packets from peer node,
(3) a console terminal (403) for input prompt and output display,
(4) a command interpreter module (404) for converting commands to a sequence of packets carrying instructions, and
(5) a packet processing module that (405) that create packets associated with the commands and handles replay packets. The command interpreter module (404) is configured to parse a command into entities, each contains information for the various fields of a packet, the information will then be retrieved and converted to values needed to insert into packet fields. The packet processing module (405) may create a packet template and particular field values based on position in the packet, and based on this an outgoing packet may be created. On the other hand, the packet processing module (405) also retrieves values from a given packet and passes these values to other components.

The basic network commands handled by the console (130) system may include:
(1) network configuration commands, for example connect/disconnect (to establish/remove structured overlay network of peer nodes); tag/untag (to tag/untag NID to the connection channels of an overlay network); lock/unlock (to lock/unlock the channels of a given NID; unlock (to unlock the channels of a given NID);

(2) network tracing commands, trace (to get overlay network topology of a given NID); net-show (to get the incoming and outgoing channels of all peer nodes on an overlay network);

(3) file and directory commands, cd (to change file directory on peer nodes of overlay network); pwd (to get the current working directory of peer nodes); mkdir (to make a new directory under the current directory of peer nodes); Is (list files and directories of peer nodes); rm (to remove files or directories of peer nodes); file-put/file-get (to send/get a file from/to console host machine to peer nodes on the net of specific NID; file-push/file-pull (to send/get a file from/to the logo-on peer node to peer nodes on the net of specific MD;

(4) program execution commands, exe-cmd (to call to run a shell command on the peer node host machines); exe-exe (to call and execute a program on peer node host machines); bundle-install/bundle-uninstall (to install/uninstall application bundles on peer nodes).

The network commands may be used with options to set the field of packets
(1) NID related options, —l NID (to specify routing NID);
(2) c routing options,
   r a path of peer nodes (to route a packet to the end of a specified path for execution);
   c a path of peer nodes (to route and execute a packet on the all nodes of the path);
   m for multicast (send to all nodes on nets specified by linear tree description);
   u for unicast (only send to the log on node);
   a for anycast (send to all outgoing child nodes);

l for endcast (send to all leave nodes);
b for broadcast (send to all nodes);
o for overcast (send to and take action on all non-relay nodes);
(3) broadcast algorithm options,
   p options, for serial, parallel, methods for broadcast;

A linear tree expression may be used as a topology description for overlay network construction and structured routing in accordance with the present invention. The linear tree expression is derived by the sequence of pairs of peer node addresses and its outgoing degree. The order of peer nodes is by the depth first traversal of the tree. The tree expression may be further converted to a stream of bytes and carried by packets in the fields for routing data of routing data (in one implementation of the invention). A particular tree expression may be defined using the CAD tool. The CAD tool generates the commands together with the associated tree expression so that the command can be called directly to create an overlay network of the topology and also the associated routing path. The negative outgoing degree of a node indicates a relay node, which just does packet forwarding.

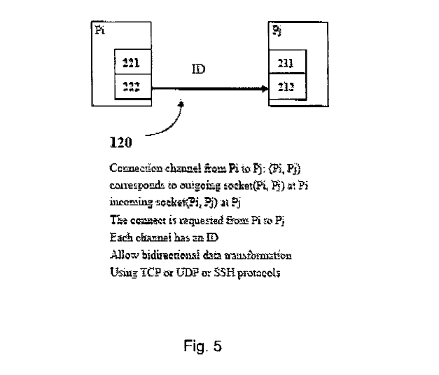

FIG. 5 illustrates one possible way to initiate the connection channels from one peer node to another. Specifically, FIG. 5 shows that a connection channel from one peer node to another may be a virtual connection with a socket on each side. The tail peer node is the peer node requesting (as client) the connection; the head peer node is the one accepting the connection (as server). The connection can be for example a TOP connection, UDP connection, or SSH connection. Each channel has an assigned identification (NID). A channel can be locked for data transfer within an application.

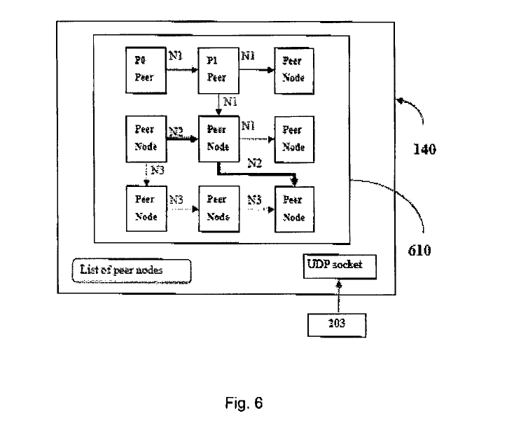

FIG. 6 is a diagram illustrating nets of an overlay network, as shown in a display window of the GUICP referred to herein. FIG. 6 depicts a representative network configuration. A P2P network enabled by the present invention may consist of a connected sub-network formed by connected channels of the same NID, which provides the basic structured data path for instruction/data packet distribution. A structured overlay network of an application comprises a group of nets used by the application. Packets are transferred along the nets. Packets can carry application data (message or stream), programs and instructions.

Referring to FIG. 6, the GUICP can retrieve the list of the current alive peer nodes, and draw a graph of active overlay networks. When a peer node is running, it reports its availability to a GUICP for example by periodically sending a UDP packet. The GUICP may be configured to periodically check the availability and interconnection relations of the peer node. With the interconnect relation information, the GUICP can draw dynamically an interconnection graph of the current overlay network. Users can also add/remove connections and do other network operations through GUICP. This enables the structured overlay networks to be configured and re-configured easily, including for the purpose of management of the P2P networks.

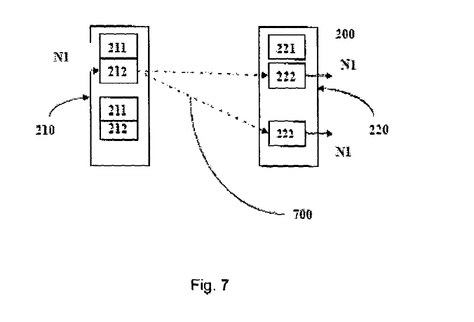

FIG. 7 is a block diagram illustrating the packet switching inside a peer node, in one particular implementation of the present invention. In one aspect of the invention, a packet switch scheme follows one or more specified protocols. As shown in FIG. 7, a packet may be forwarded to outgoing channels by channel handler (211), either by given specific outgoing peer nodes, or by NID. In one particular implementation of the invention, when a packet arrives at a peer node, the channel handler (211) picks up the packet and checks its routing protocol value and information and routing data in the packet, then decides which outgoing channel to pass to, for example based on a specified routing operation (which may be implemented using a suitable routing algorithm), which may be implemented to the channel handler (211). When an outgoing channel is determined, it then builds a corresponding packet by the routing information and routing data, and writes the packet to the outgoing channel.

For example, an application running on a prior art P2P based reconfigurable computing system usually has a plurality of computing components running on a plurality of peer nodes. In accordance with the present invention, however, a computing component can be an internal thread (233) of a peer node process, or an external process (231, 232) with I/O interface to the peer node. These computing components are interconnected by the application specific structured overlay network. Data may be exchanged between these components through the overlay network enabled by the present invention. The overlay network can be fixed within the life time of an application, or changed dynamically based on conditions within the application (for example using triggers defined by the application and associated with “events” logged to the application).

Designing an application using the P2P based computing system in one aspect of the invention may involve (1) decomposition of a computing scheme, i.e. decomposing the application into computing components that each can be run on a peer node computer or device, (2) deriving a structured overlay network connecting different computing components required by the application, (3) computing the optimal mapping and network topology and overlay reconfiguration context generation, (4) configuring the overlay network by deploying to the computing components, (5) execution of the application, and (6) optionally managing the application (e.g. mentoring of performance, cleaning etc.).

What follows is an example of designing a data collection application, based on the present invention that is operable to collect data from a large number of peer nodes periodically. (A) The data collection application may include, in one implementation, a components master component (which may be implemented as a master computer program), a database, a data queue, a worker component, and data generator. The master program may be running on one more peer nodes. Databases and data queues are associated matters. The master may take data from data queue and insert into database. The worker component is operable to run remote nodes, and process a number of remote node management operations. For example, the worker component may monitor the queue, and depending on the application if there is sufficient data in the queue, the worker monitor may initiate the transfer of the data to the parent, or store the data to temporary store.

The worker program and data queue may be running on a relay node. The worker component may be configured to (A) take data from local data queue and (B) insert them to one or more data queues in other peer nodes. The worker component, the data queue and the data generator are running on end peer nodes where data originated. The data generator periodically or based on events obtains data from local device, and inserts the data to data queue. The generator may be device dependent.

The worker component may be further configured to map the components to the intended peer nodes, and compute the topology connection master nodes to all end nodes, which determines the parent nodes that a worker need to send data to. Relay nodes may be introduced based on communication constraints, and to improve efficiency. A worker component may have one more parents for fault tolerance. The worker component may also generate dynamically a component package for each node including their specific configurations, programs for installation, start, management and un-installation. The worker components may start the installation program, which distributes the component packages to their destination peer nodes and does the proper configuration for each node. The worker component may also start the application by calling the start program, which sends a starting instruction to all the nodes. The worker component may then initiate running of the management program which monitors the status of data queue, performance worker, reconfigures workers, and stop and restart workers and clean data queue, updates the components, trouble shooting when node device is malfunction. The worker component may then run the uninstall program which removes all the components on all nodes.

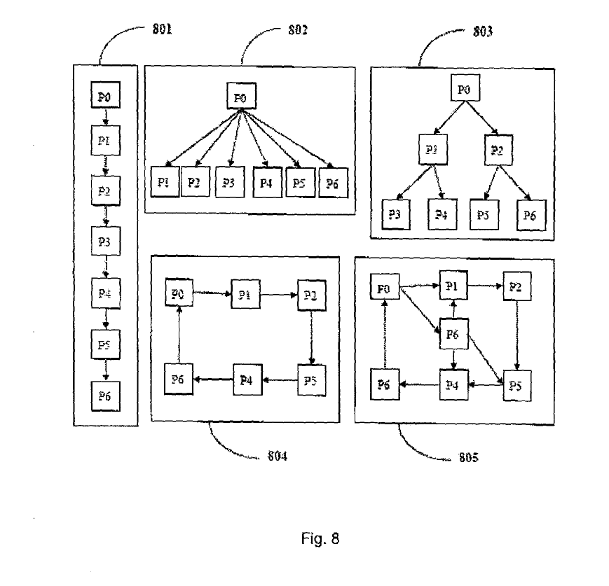

Referring to FIG. 8, a net in a structured overlay network may have a variety of topologies, such as for example a path, star, tree, ring or more general graph. The network topology plays an important role in the performance of data distribution along a structured overlay network. In one implementation of the invention, designing a P2P network topology for a particular application is completed using the CAD design tool.

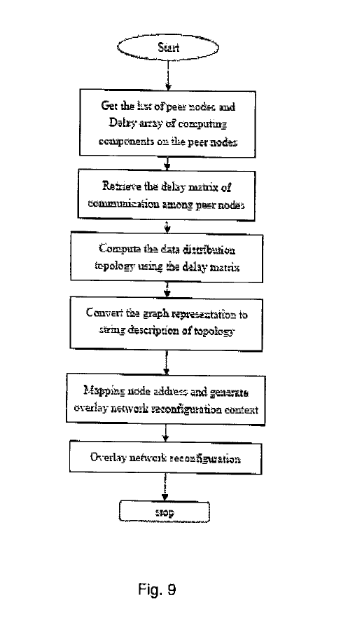

FIG. 9 is a workflow diagram illustrating a possible workflow for use of the CAD tool to design an overlay network topology for enabling P2P networks in accordance with the present invention. Referring to FIG. 9, a representative workflow enabled by the CAD design tool may involve (A) computing resource information gathering (for example regarding peer nodes and their computing power), the communication delay among peer nodes, topology and mapping computing, reconfiguration contest generation. The delay matrix denotes time delay of transferring a packet between any given pair of peer nodes. If two peer nodes cannot be connected directly, the delay between them is set to infinity. (B) The delay matrix is derived and updated as a utility of the system, which first connects given nodes in simple topology such a path then sends the ping instruction together with ping targets to all nodes. Each node pings the given targets and retrieves the time data and send all the data to parent. The root node collects the return delay information and inserts this information into delay matrix which is either in form of a file or a database. The delay matrix may be used by one or more CAD algorithms for finding the optimal overlay network topologies associated with applications.

In one example of the implementation of the invention, three data distribution protocols are provided for use along a structured overlay network:

(1) An edge-based data distribution protocol (EDDP), in which each file transmission starts from a peer node, say P, to another node P′, along the channel (P, P′). When the transmission is done, peer node P′ receives the data (saved). After a peer node receives the data, it then transfers the data to its outgoing neighbors one after another. The data distribution is completed when all peer nodes on the overlay network receive the data.

(2) A level-based data distribution protocol (LVDP) may also be used which after a node receives a data, it then starts to send the data to all its outgoing neighbors simultaneously and ends when all the outgoing neighbors receive the data. The data distribution terminates until all nodes of the overlay network receive the data.

(3) A tree broadcast based data distribution protocol (TDDP) may also be used in which the source node starts sending data blocks to all nodes along the tree topology simultaneously and ends when all nodes receive all data blocks.

All the three protocols referred to above distribute data along a given overlay network in parallel. This parallel feature is a key factor that accelerates the file distribution over structured overlay networks.

### EXAMPLE

### In Operation

The operation of the present invention may be illustrated using an example. P2P based reconfigurable computing using packet based communications are illustrated in connection with a representative file distribution application in accordance with the present invention. The basic task of this application is to distribute a file from a source peer node to n sink peer nodes. It has been shown generally that the optimal topology for a single source file distribution is a tree.

Let V={P₀, P₁, . . . , Pₙ₋₁} denote the set of all peer nodes. Denote by socket(Pᵢ, Pⱼ) the connection channel from Pᵢ to Pⱼ, and t(Pᵢ, Pⱼ) the time delay to send a packet of standard size from Pᵢ to Pⱼ through channel socket (Pᵢ, Pⱼ). The channel socket (Pᵢ, Pⱼ) corresponds to a directed edge (Pᵢ, Pⱼ) of an overlay network graph. Let T=(V, E) be a directed tree rooted at P₀, then T corresponds to an overlay network over nodes V, with each edge (Pᵢ, Pⱼ) of E corresponds to a channel socket(Pᵢ, Pⱼ). Let D⁺_{T}(P) be the set of all outgoing nodes of P in T. Assume that node P₀ is the source node with file F to be distributed, and all other sink nodes P₁, . . . , Pₙ₋₁. Note that given a tree description of T, a network command can be used to reconfigure the interconnection of peer nodes to a topology of T. After the interconnection of T is established, the file distribution can be done over T according to a given data distribution protocol.

The delay estimation t_{T}(P₀) for distribution a standard size packet from P₀ to P₁, . . . , Pₙ₋₁ along a tree T by EDDP can be computed bottom up by the following formula:

$${t}_{T} ( P ) = max \{ {\sum }_{h = 1}^{j} t ( P , {P}_{π0 ( {i}_{h} )} ) + {t}_{T} ( {P}_{π0 ( {i}_{h} )} ) , j = 1 , … , k ) ,$$

where P is node of T, D⁺_{T}(P)={Pᵢ_{₁}, . . . , Pᵢ_{ₖ}}, and π₀ is a permutations of {i₁, . . . , iₖ} with sorted values t_{T}(P_{π0(i}_{₁}₎)≧tᵣ(P_{π0(i}_{₂}₎)≧ . . . ≧t_{T}(P_{π0(ik)}). t^{T}(P₀) can be computed in time O(n log n). The algorithm used to determine an overlay network topology may be as follows.
Step 1. Let V={P₀}, E=φ, T=(V,E), t(P₀)=0, s(P₀)=0, A={P₀}, B={P₀, P₁, . . . , Pₙ₋₁}\A.
Step 2. If |B|=0, output T and stop.
Step 3. If |A|>0, find a PεA and P″εB such that t(P′)=t(P)+s(P) is minimum among all edges from A to B. Set V=V∪{P}, E=E∪{(P,P′)}, A=A\{P}, B=B\{P′},and s(P)=s(P)+t(P,P′), t(P′)=t(P)+s(P), s(P′)=0. Go step 2.
Step 4. If |A|=0, reset A to be the set of all nodes of T=(V, E) with outgoing degree less than b. Go to step 2.

This algorithm derives the optimal solution when the delays are constant. The bound b may be used to balance the outgoing traffic of peer nodes.

The delay estimation t′_{T}(P₀) to distribute a standard size packet from P₀ to P₁, . . . , Pₙ₋₁ along a tree T by LIMP can be computed bottom up by the following formula.

$${t}_{T}^{′} ( P ) = {\sum }_{{P}^{′} ∈ {D}_{T}^{+} ( P )} t ( P , {P}^{′} ) + max \{ {t}^{′} ( {P}^{′} ) \cdot {P}^{′} ∈ {D}_{T}^{+} ( P ) \}$$

The overlay network topology for SDDP can be derived by the following algorithm:

Step 0. Given V={P₀, P₁, . . . , Pₙ₋₁}, b≧1, t(Pᵢ, Pⱼ)>0, i, j=0, . . . , n−1.
Step 1. Let V′={P′₀, P₁, . . . , P′_{n˜1}}. If b=1, let T′(n) as a path of n nodes.
Step 2. If b=2, let T′(n) a balanced 2-tree of n nodes.
Step 3. If b>3, let i=0 and T′₀=({P′₀}, φ). If n=1, let T′_{b}(1)=T′₀=({P′₀}, φ). Let T′_{b}(1).
Step 4. Compute n′ᵢ from i=1 to j such that n′ⱼ<n≦n′ⱼ₊₁. Let h=n′ⱼ₊₁
Step 5. Construct T′_{b} (h) recursively as follows. n′ⱼ₋₁=2n′ⱼ₋₁+1, then construct T′ⱼ₋₁ by joining P′₀ to the roots of T′ⱼ₋₁ and T′ⱼ₋₁. Continue to construct T′ⱼ₋₁. Else n′ⱼ₊₁=3n′ⱼ₋₂+1, construct T′ⱼ₊₁ by joining P′₀ to the roots of T′ⱼ₋₂ and T′ⱼ₋₂. Continue to construct T′ⱼ₋₂.
Step 6. Remove n′ⱼ₊₁−n leaf nodes from T′_{b}(h), return the resulted tree T′_{b} (n).
Step 7. Let Q be a queue of the nodes of T′(n) in bread-first order starting from the root.
Step 8. Let P′₀ be the first node in queue Q. Map P₀ to P′₀ by setting M={(P₀′, P₀)}, T=({P₀}, φ), V=V\{P₀}, and removing P′ from V′. If V=φ, output T′(n)=T, stop.
Step 9. Let P′ be the next node in queue Q. Find the parent P″ of P′ in T′(n) and the mapped node Pᵢ of P″ from M (i.e., (P″, Pᵢ)εM). Find PᵢεV such that t(Pᵢ, Pⱼ)=min{t(Pᵢ, Pₕ): Pₕ:εV}. Map Pⱼ to P′ by setting M=M∪{(P′, Pⱼ)}, T=T+(Pᵢ, Pⱼ), V=V\{P}, and removing P′ from Q.
Step 10. If V=φ, output T′(n)=T and stop; otherwise go to step 9.

This algorithm derives the optimal overlay network for LDDP when the delays are constant.

The delay t″_{T}(P₀) to distribute a standard size packet from P₀ to P₁, . . . Pₙ₋₁ along a tree T by TDDP can be estimated by computing bottleneck b(T) of the tree and the delay estimation of EDDP.

$${b}_{T} ( P ) = max \{ {\sum }_{{P}^{′} ∈ {D}_{T} ( P )}^{j} t ( P , {P}^{′} ) , max \{ {b}_{T} ( {P}^{′} ) : {P}^{′} ∈ {D}_{T} ( P ) \} \}$$

$$b ( T ) = {b}_{T} ( {P}_{0} ) = max \{ {\sum }_{{P}^{′} ∈ {D}_{T} ( P )}^{j} t ( P , {P}^{′} ) : P ∈ T \}$$

$${t}_{T}^{″} ( {P}_{0} ) = mb ( T ) + {t}_{T} ( {P}_{0} )$$

Where m is the number of data blocks to be distributed. When m is large, we use a spanning tree T of with the minimum outgoing weight. That is,

$$b ( T ) = min \{ max \{ {\sum }_{{P}^{′} ∈ {D}_{T} ( P )}^{j} t ( P , {P}^{′} ) : P ∈ T \} \} .$$

When n is large, t_{T}(P₀) dominates, use tree derived by the EDDP algorithm.

In the case of distributing a sequence of files, EDDP, LDDP and TDDP may be applied in a non-pipelined style, in which the P2P network system distributes the next file after all peer nodes of the overlay network receive the previous file.

File distribution with EDDP and LDDP can also be done in pipelined style in which a peer node starts to distribute the next file whenever it finishes distribution of a file and has a file in queue. The unsynchronized pipelined style with TDDP can be done at data packet level. That is, a peer node starts sending a data packet to next peer node as long as the peer node is ready to receive a new data packet, and a peer node is ready to receive after it sends out the previous data packet.

Data distribution along a net can also be synchronized. That is next packet can only be issued after the previous one arrives at the destinations and a feedback is received. Data distribution along a net can also be unsynchronized. That is, a packet arrives at a peer node, a quick feedback is sent back, so that the next packet can be sent. First-in-first-out buffers may be used to hold the arrived packets.

Data distribution methods may be configured to include fault tolerance. Check sum or digest operations can be used to make sure that data transfers are correct along each connection. For example if a check sum is not correct, it signals the parent peer node to redo the data transfer.

### Comparison of Performance to Prior Art Technologies

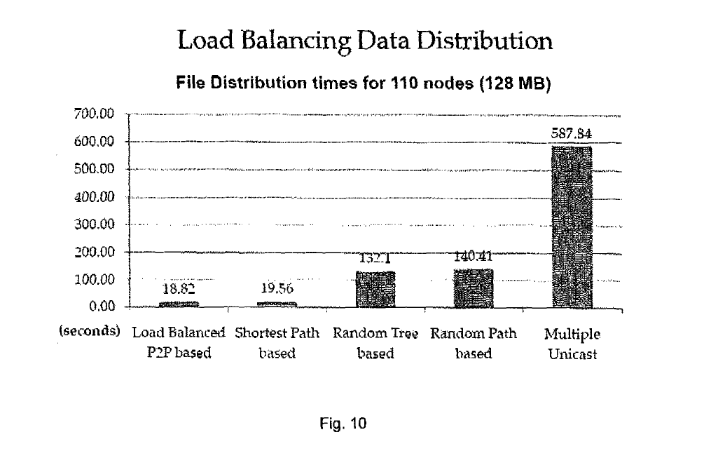

In one example of the implementation of the present invention, a test of operation of a representative system in accordance with the present invention involves distribution of a file having a size of 128 MB to 110 nodes. As shown in the chart shown in FIG. 10, the results were as follows: (A) a traditional multiple unicast method took 587 seconds to distribute the file across the nodes, while (B) structured data path methods took 140 seconds with a random path topology, 132 with a random tree topology, 19 seconds with the tree topology obtained by shortest path based Steiner tree algorithm, and 18.82 seconds with a tree topology obtained by the clustered Steiner tree algorithm. The first four columns from the left illustrate performance in this example using prior art topologies and technologies. The column at the right illustrates performance using the present technology, which may be referred to as a multicast technology and P2P network topology.

### Examples of Applications

The present invention may be implemented in a number of ways.

In one implementation, the computer system may be implemented as a communication middle ware system for a number of different applications.

The P2P networks of the present invention may be implemented using wired and/or wireless networks.

The P2P network of the present invention may be used to connect various types of devices, including for example a sensor network. One advantage of the present invention is that sensors can connect themselves to form their own network, and then for example dynamically share performance data, or optimization data.

In one example of implementation of the invention, the invention may be used for smart grid applications require the monitoring and control of many electric consumption devices. Control may be exercised for example using one or more control hubs that are associated with networks or sub-networks for collecting information from electric consumption devices. Smart grid applications often require for example distributed intelligence, automated control operations, and real-time market transactions involving large numbers of computer devices, organized based on various different network hierarchies.

In one application, the P2P computing platform of the present invention may be configured to provide the supervisory, control and data acquisition (SCADA), information processing and services required by a smart grid network at large scale. For example, the P2P computing platform of the present invention may be used to enable communication between master stations/gateways to operation/data centers, and data exchange among computing components of distributed computing of Smart Grid applications.

Centralized network architectures are generally not suitable for real time SCADA and information processing. This is because with the significant number of SCADA requests in a commercial smart grid network, prior art centralized systems tend to have a poor quality of service (QoS). Also, centralized solutions are generally application specific with dedicated communication and computing resources, therefore there are high costs of development because of lack of flexibility of prior art systems in that they do not readily support the addition of new applications.

The idea of decentralized smart grids has been proposed in the prior art, however, prior to the present invention there has not been a decentralized computing platform that meets the requirements of a smart grid network in regards to reliability, security, throughput and latency against the broad range of locations of data source and efficient utilization of computing resources (CPUs, programs, memory and data storage) and communication resources.

In one example of an application based on the present invention, the P2P computer platform of the present invention may be used as a communication middleware system to handle the data communications for multiple smart grid applications.

The system consists of peer nodes, operating software and application programming interfaces (APIs), as well as a software development kit (SDK). A peer node may be a software component or a hardware component.

As a software component the peer node component may be embedded in a computer consisting of an edge server, a hub, an operation centre, or cloud network. As a hardware component the peer node component can be embedded in a gateway, a master station or a data link device.

Peer nodes can form virtual networks, in which data packets are routed for the middle and high level communications required to manage the smart grid. A peer node based on the present invention is capable of executing a specific set of instructions including calling local functions, data I/O with its local device and processes, executing instructions carried by packets, and connecting to other peer nodes to form TCP/IP channels to send/receive/route data packets.

For a one-to-one, one-to-many or many-to-many data communication request, a group of peer nodes is first identified and routing algorithms are then called to find a structured network topology (typically a Steiner tree) and then construct an overlay network through fast reconfiguration of the peer nodes. The data transportation for the communication request is through the structured overlay network,

Different overlay networks may be given different IDs, and do not interfere with each other even if they overlap. Therefore multiple applications can use the system simultaneously.

Operation of the communication middleware system occurs through command consoles by logging on to peer nodes manually or automatically. A real time monitoring and control system may be used to manage the middleware system for dynamic data traffic information and control, as well as to provide delay information for routing algorithms. Application programs use the middleware system for data communication through API calls.

The SDK is used to develop distributed computing applications of the Smart Grid.

### Network Management Operations

Various network management operations may be used in connection with the present invention. These operations may be based on self-reconfiguration features implemented to the peer nodes, by operation of the console. For example, the computer system of the present invention may implement a self-healing mechanism, which may be used to reconnect a channel if a channel stops functioning for a period of time within an application. When a peer node stops functioning, an interrupt can be raised and the interrupt routine can be called to restart the peer node or to reconfigure the overlay network. Similarly, the system may implement self-testing features, error/fault detection features, interrupt routines, and/or fault tolerance policies.

### Other Applications

A skilled reader will appreciate that various other applications of the P2P computing platform of the present invention are possible, including for example:
(A) A communication middleware system for massive data distribution for example for streaming services, or Internet TV, where the structured overlay networks may be configured on an on demand basis. For example, to broad live TV steam to large number of audiences may be done by distributing the steam video data from content source to a group of over end servers using the P2P peer node network. A receiver can then download the video stream from a nearby end server,
(B) Computing resource management systems for distributed computing applications including structured overlay networks. First of all, using the structured overlay network, a network manager can retrieve system resource status of all available computers in real time. Secondly, using the resource information network manager can map and dispatch computing tasks to one or more peer node computers through overlay network.
(C) Data/file synchronization among network-connected devices, including mobile devices, for example in connection with file sharing services, location based services, or presence based services. To do data synchronization of data on multiple nodes using the P2P network, a hash table may be set on each nodes, universal time reference can be distributed along a bidirectional net to all nodes (with a short delay), a time difference between the universal time and local time a the time of getting the universal time reference is calculated and stored in the hash. The universal stamp at a node and at any time is calculated by local time plus the difference. When a data is generated at a node, the universal time stamp is added. The data set is distributed to all nodes along the net asynchronously, a processing element take a sync data set from a queue and insert into synch hash if its time stamp is bigger than the time stamp in the data set of the same key. In case of file sync, a hash table may be used to hold file info and actual file distribution is taking place when an adding file is new or younger than the existing file.
(D) Real time monitoring, data collection and control of smart devices, such as for example in industrial systems that includes networks of sensors.

A skilled reader will also appreciate that the computer platform may be used for push based applications as well as pull based applications.

1. A computer implemented method for configuring and reconfiguring peer-to-peer (“P2P”) networks is provided characterized in that the method comprises:
(a) designing and configuring a structured overlay network for defining a P2P network;
(b) generating network instructions using one or more protocols that define a packet format, the network instructions being operable to define the structured overlay network; and
(c) distributing the network instructions to two or more network-connected host devices so as to define dynamically the structured overlay network, such that each host device is a peer node, and the structured overlay network enables data exchanges between peer nodes to as to enable peer-to-peer operations between the peer nodes.

2. The method of claim 1, wherein the structured overlay network defines a decentralized network architecture that enables file distribution, data synchronization or search, over the host devices.

3. The method of claim 1, wherein the structured overlay network creates dynamic structured data paths between peer nodes.

4. The method of claim 1, wherein the structure overlay network enables the implementation of distributing computing applications across the P2P network.

5. The method of claim 1, wherein the P2P networks are flexible and scalable, and also enable control of peers that permits configuration and re-configuration.

6. The method of claim 1, wherein the network instructions may be adapted to define P2P network closure parameters that are triggered to close the P2P network.

7. The method of claim 2, wherein the P2P network are adaptive.

8. The method of claim 1, wherein the network instructions are in the form of network packets, and these define for each peer node, an incoming channel and an outgoing channel, and further define a channel handler for each incoming channel for controlling the network packets.

9. A computer network implemented system is provided for configuring and reconfiguring peer-to-peer (“P2P”) networks characterized in that the system comprises:
(a) a P2P network manager implemented to a server computer, the P2P network manager being configured to:
(i) generate network instructions using one or more protocols that define a packet format, the network instructions being operable to define ae structured overlay network; and
(ii) distribute the network instructions to two or more network-connected host devices so as to define dynamically the structured overlay network, wherein each host device is a peer node, and the structured overlay network enables data exchanges between peer nodes to as to enable peer-to-peer operations between the peer nodes.

10. The computer system of claim 9, further comprising two or more network-connected devices that after receiving the network construction include a peer node component, and function as peer nodes in a decentralized P2P network.

11. The computer system of claim 9, wherein the structured overlay network defines a decentralized network architecture that enables file distribution, data synchronization or search, over the host device.

12. The computer system of claim, wherein the structured overlay network creates dynamic structured data paths between peer nodes.

13. The computer system of claim 9, wherein the structure overlay network enables the implementation of distributing computing applications across the P2P network.

14. The computer system of claim 1, wherein the P2P networks are flexible and scalable, and also enable control of peers that permits configuration and re-configuration.

15. The computer system of claim 9, wherein the network instructions are in the form of network packets, and these define for each peer node, an incoming channel and an outgoing channel, and further define a channel handler for each incoming channel for controlling the network packets.

16. The computer system of claim 9, wherein the P2P network manager is operable to:
(a) retrieve an overlay network topology and an overlay network topology expression; and
(b) apply an overlay network topology for data distribution and reconfiguration context generation.

17. The computer system of claim 9, wherein the network instructions define on each peer node a worker component that monitors and controls peer node functions.

18. The computer system of claim 9, wherein the network instructions are in the form of network packets, and these define for each peer node, an incoming channel and an outgoing channel, and further define a channel handler for each incoming channel for controlling the network packets.
